(19) United States
(12) Patent Application Publication
(10) Pub. No.: US 2018/0082322 A1
(43) Pub. Date: Mar. 22, 2018

(54) METHODS AND SYSTEMS FOR OPERATING A LOYALTY PROGRAM

(71) Applicant: MASTERCARD INTERNATIONAL INCORPORATED, Purchase, NY (US)

(72) Inventors: Geetika Sharma, New Delhi (IN); Charu Jain, Jalen Daud (SG)

(21) Appl. No.: 15/707,674

(22) Filed: Sep. 18, 2017

(30) Foreign Application Priority Data
Sep. 21, 2016 (SG) 10201607866R

(51) Int. Cl. G06Q 30/02; G06F 17/30

(52) U.S. Cl. CPC G06Q 30/0227; G06Q 20/34; G06F 17/30283; G06Q 30/0233

(57) ABSTRACT

A computer implemented method of operating a loyalty program using a computer system is provided. The method includes transmitting to communication devices associated with a corresponding plurality of consumers, who are members of the loyalty program, information describing at least one merchant, wherein the at least one merchant is a merchant that does not currently offer products in return for loyalty points of the loyalty program. The method further includes receiving, from the communication devices, selection data characterizing selections from among the at least one merchant. The method further includes collating the selection data to identify the at least one merchant, wherein the at least one merchant was selected by a number of the consumers that meets a criterion, the criterion indicating that the at least one merchant has been selected by a large number of the consumers.

### CROSS REFERENCE TO RELATED APPLICATIONS

This patent application claims priority to Singapore Application No. SG 10201607866R, filed on Sep. 21, 2016, the disclosure of which is incorporated by reference herein in its entirety as part of the present application.

### BACKGROUND

The present disclosure relates to computer-implemented methods and computer systems for operating a loyalty program.

It is common for a merchant to organize a loyalty program for its customers. Typically, a customer is provided with a physical loyalty card, which is typically a piece of paper or plastic carrying an account number. The account number is the number in connection with a loyalty account for storing loyalty points earned by the customer. Whenever the customer makes a purchase at a point-of-sale (POS) of the merchant, they present the loyalty card. Depending on the value of the purchase, the merchant determines a corresponding number of loyalty points, and credits that number of loyalty points to the account associated with the corresponding card. The accumulated loyalty points can be used to obtain rewards, such as goods and/or services (collectively referred to here as “products”) or a discount on a future purchase from the merchant. The advantage of the rewards system for the merchant is that once the customer has accumulated some loyalty points, he or she is more likely to make future purchases from the same merchant in the hope of eventually earning a reward.

Other loyalty programs are operated by companies other than merchants. For example, sometimes a payment card issuer operates a loyalty program in which consumers are rewarded with loyalty points for making purchases using a payment card. The payment card issuer may offer a range of products which may be obtained using the loyalty points, and/or may permit the payment card holder to convert the loyalty points into loyalty points of a different loyalty program.

Known loyalty programs have a number of disadvantages. The disadvantages include, but are not limited to, (i) a lack of reward relevance (the rewards offered do not fit well with the desires of the consumers), (ii) lack of flexibility, and (ii) poor value. These factors defeat the purpose of offering a loyalty program, namely to improve customer engagement with the operator of the loyalty program.

### BRIEF DESCRIPTION

The present disclosure aims to provide new and useful computer-implemented methods for operating a loyalty program, and new and useful computer systems for performing the methods for operating a loyalty program.

In general terms, the disclosure proposes that a plurality of consumers who are members of a computer-implemented loyalty program are prompted to provide data input, which is selection data identifying organizations (candidate merchants), which are not currently associated with the loyalty program in the sense of providing offers, which can be redeemed using loyalty points. The results for the plurality of consumers are collated, and one or more of the candidate merchants are identified, which were selected by a high number of the consumers.

Upon such candidate merchant(s) being identified, a process may be carried out to add the identified candidate merchant(s) to the program. Once this is done, loyalty points of the loyalty program can be redeemed for products supplied by the identified candidate merchants.

Thus, consumers are given a say in their choice of rewards, which is known as consumer empowered personalization. This is in keeping with an important trend which is presently observed in a variety of brands in various industries.

Consumers who are prompted to provide the selection data may be ones who have indicated that they intend to use their accumulated loyalty points in one of a set of one of more predetermined ways. The set of predetermined way(s) of using the loyalty cards may be ones which are of low benefit to the operator of the loyalty program. For example, one of the predetermined way(s) may be converting the loyalty points to a monetary (cash) amount. Another of the predetermined way(s) may be converting the loyalty points into loyalty points in another loyalty program (e.g. operated by a different loyalty program operator). It is particularly beneficial to provide additional redemption options to consumers who are using their loyalty points in one of the set of predetermined ways, to encourage them to use their loyalty points to in a way which is preferable to the operator of the loyalty program. For example, if those consumers can instead be persuaded to use their loyalty points to obtain merchandise, this opens an additional channel of revenue to the operator of the loyalty program.

The selection data may be in the form of, or form input to, a command to transfer loyalty points of the loyalty program to a loyalty program operated by one of the candidate merchants.

The selection data provided by the consumers provides valuable information about them. The selection data may be analyzed to obtain data characterizing purchase preferences of the consumers.

In one embodiment, the operator of the loyalty program is also an operator of a payment card network, and/or an issuer of payment cards, and the loyalty program relates to loyalty points which the consumers earn by using the payment card(s).

As used in this document, the term “merchant” refers to an organization which provides products (goods and/or services) to consumers, in exchange for loyalty points of a loyalty program.

As used in this document, the term “payment card” refers to any cashless payment device associated with a payment account, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, transponder devices, NFC-enabled devices, and/or computers. Furthermore, the “payment card” may exist only as a data structure (i.e. without physical existence), which is registered with a digital wallet or cloud wallet.

As used in this application, the terms “component,” “module,” “engine,” “system,” “apparatus,” “interface,” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

The disclosure may be implemented as a method, apparatus, or article of manufacture using standard programming and/or engineering techniques to produce software, firmware, hardware, or any combination thereof to control a computer to implement the disclosed subject matter. For instance, the claimed subject matter may be implemented as a computer-readable medium embedded with a computer executable program, which encompasses a computer program accessible from any computer-readable storage device or storage media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ).

### BRIEF DESCRIPTION OF THE DRAWINGS

An example embodiment will now be described for the sake of example only with reference to the following drawings, in which:

FIG. 1 shows schematically a computerized network arranged to perform a method which is an embodiment of the present disclosure;

FIG. 2 is a flow-chart of the method which is an embodiment of the disclosure; and

FIG. 3 shows schematically the structure of a server which can be used in the computerized network of FIG. 1, and which is itself an embodiment of the disclosure.

### DETAILED DESCRIPTION

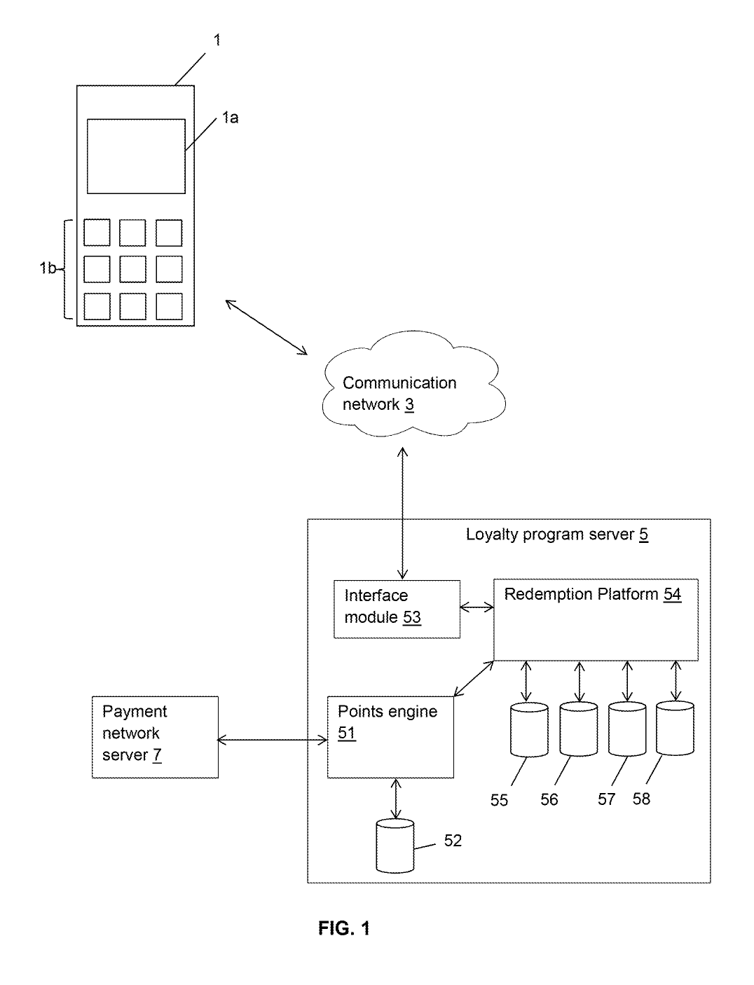

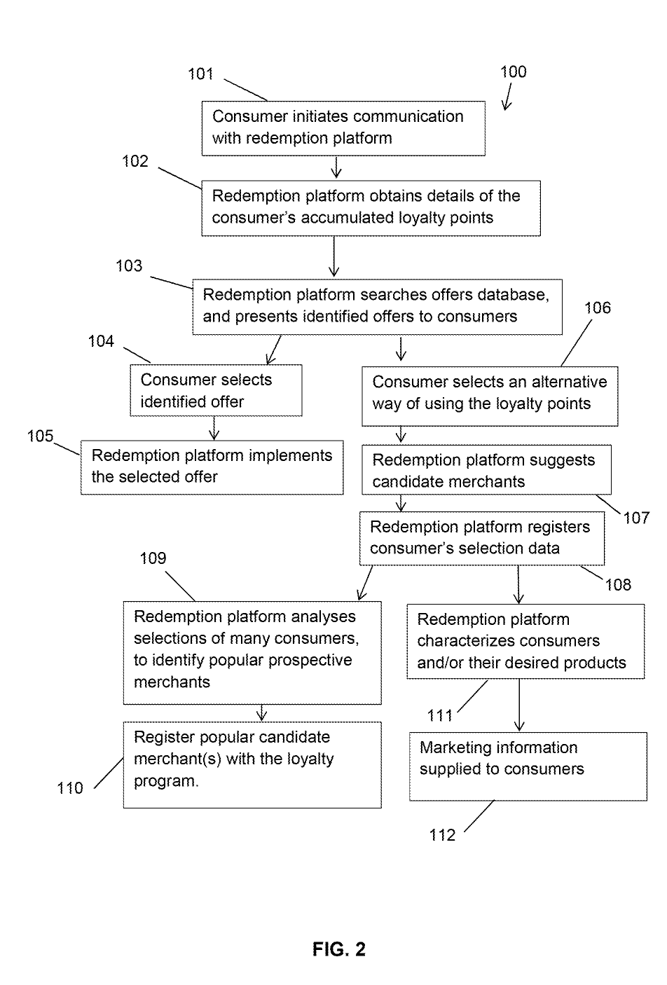

Referring to FIG. 1, a computerized network is shown, including a loyalty program server 5 which is an embodiment of the disclosure. The computerized network can perform a method 100 which is another embodiment of the disclosure, and which is illustrated in FIG. 2.

The loyalty program server 5 is for operating a loyalty program. Like known loyalty program servers, the loyalty program server 5 includes a points engine 51 which manages respective loyalty accounts for a plurality of consumers. Details of the accounts are stored in an accounts database 52.

In one embodiment, the points engine 51 communicates with a payment network server 7 which operates a payment card network. Consumers hold one or more payment cards, and when a consumer makes a payment transaction using one of the payment cards, the payment network server 7 sends a message to the points engine 51 with details of the payment transaction, so that the points engine 51 can calculate how many loyalty points the consumer has earned by the transaction, and accordingly credit that number of points to the consumer's loyalty account by updating the accounts database 55.

Many embodiments of this arrangement are possible. In one embodiment, the payment network server 7 may be integrated with the loyalty program server, such that a single server manages both payment transactions using payment cards, and the associated loyalty program.

In another embodiment, the payment network server 7 is replaced by an issuer bank server operated by an issuer bank which issues payment cards to the consumers. In this embodiment, the issuer bank server informs the payment engine 51 when a payment transaction is made using one of the payment cards issued by the issuer bank, so that the payment engine 51 may update a corresponding loyalty account of a consumer associated with the payment card. Again, the issuer bank server may be integrated with the loyalty program server 5, such that a single server manages both payment transactions using payment cards, and the associated loyalty program.

In a yet further embodiment, the points engine 51 is in communication with one or more merchant server(s) operated by one or more corresponding merchants. The merchant server(s) inform the points engine 51 of any payment transaction made to the corresponding merchant by one of the consumers, together with information identifying the consumer and/or the consumer's loyalty account, so that the points engine 51 can credit a corresponding number of loyalty points to the corresponding loyalty account.

These embodiments may be combined, such that that the points engine 51 is informed by a payment network server or issuer bank server, of payment transactions involving a payment card, and the points engine 51 is also informed by merchant server(s) of payment transactions made to the corresponding merchants, and in either case the points engine 51 credits one or more loyalty points to the corresponding consumer's loyalty account, by updating the accounts database 52.

Any given consumer may use a communication device 1 to communicate over a communication network 3 with a communication interface 53 of the loyalty program server 5. The communication device 1 includes a screen 1a and one or more data input devices 1b. In FIG. 1, the communication device 1 is shown as a smartphone, but it may be another mobile communication device (e.g. a tablet computer), or indeed a personal computer (PC). Although only a single communication device 1 is illustrated in FIG. 1, it is envisaged that the loyalty program server 5 will communicate with a large number of consumers, who use respective communication devices.

We now turn to an explanation of the method 100. Using the communication device 1, the communication network 3 and the interface module 53, the consumer is able to initiate communication with a redemption platform 54 of the loyalty program server 5 (step 101 of method 100). This may include a log-in procedure, e.g. using a password.

Upon a consumer communicating with the redemption platform 54, the redemption platform communicates with the points engine 51 (step 102) to obtain from the accounts database 52.

As in known loyalty program servers, the redemption platform 54 is able to access an offers database 55 which stores offers of products (goods and/or services) which the consumer is able to obtain using accumulated loyalty points (optionally, some of the offers may require loyalty points in combination with a monetary payment by the consumer). These offers are provided by corresponding ones of a predetermined set of merchants associated with the loyalty program (“associated merchants”). In step 103, using the number of accumulated points obtained in step 102, the redemption platform 54 searches the offers database 55 (optionally using also data provided by the consumer indicating a product the consumer would like) to identify matching offers, and transmits data over the interface module 53 and the communication network 3 to the screen 1a of the communication device 1, to instruct the communication device 1 to present the identified offers to the consumer.

In step 104, the consumer may give data input using the data input devices 1b to select one or more of the identified offers. The communication device 1 transmits this selection to the rewards platform 54.

In step 105, the rewards platform 54 implements the selected offer. Typically, a number of loyalty points specified in the offer are subtracted from the consumer's loyalty account, and a message is sent to the merchant associated with the selected offer instructing the merchant to supply the product to the consumer.

Additionally in step 103, the redemption platform 54 may inform the consumer that there are one or more additional ways of using the loyalty points, such as converting the loyalty points into money (e.g. cash, or a payment credited to the payment card account, or for a gift voucher or prepaid payment card) or converting the loyalty points into loyalty points in another loyalty program. These options are not as advantageous to the operator of the loyalty program as the consumer using the loyalty points to accept one of the identified offers.

If instead of selecting one of the identified offers, the consumer selects one of the alternative way(s) of using the loyalty points (step 106), this information is transmitted by the communication device 1 to the redemption platform 54.

In step 107, the redemption platform 54 extracts from a candidate merchant database 56 details of one or more merchants which are not presently associated merchants (“candidate merchants”). These details are transmitted to the screen 1a of the communication device 1. The candidate merchants may be ones who operate their own loyalty programs, and the consumer may be informed that one of the ways of using his/her accumulated loyalty points is by transferring them to a loyalty program of a candidate merchant.

The consumer selects one or the candidate merchants using the communication device 1, which transmits selection data indicating the selection to the redemption platform 54. In step 108, the redemption platform 54 stores those choice(s) in a choices database 57. If the consumer was informed that he/she had the option of transferring some or all of their accumulated loyalty points to a loyalty program of the candidate merchant, then that process is now carried out. This may include communicating with the communication device 1 to ask the consumer to provide an account number for the loyalty program of the candidate merchant.

Optionally, the consumers who select one of more of the candidate merchants are rewarded, such as by being granted bonus loyalty points in the loyalty program of the selected candidate merchants.

Note that in a variation of the embodiment, step 107 may be incorporated into step 103 (rather than being performed after a step 106). In other words, the redemption platform 54 may supply the information about the candidate merchants to the communication device 1 at essentially the same time as providing the communication device 1 with the information about the identified offers.

The steps 101 to 108 are performed many times by different ones of the consumers, so that data is accumulated in the choices database 57.

Periodically (for example, once every few months), in step 109, the redemption platform 54 analyses the selection data in the choices database 57, to identify the candidate merchants for which the selection data meets a criterion which indicates that the candidate merchants were selected by a large number of the consumers. For example, reward platform 54 may identify those of the candidate merchant(s) which were selected by the greatest number of consumers. Alternatively or additionally, the reward platform may identify any of the candidate merchant(s) who were selected by a number of the consumers which is above a predetermined threshold.

In step 110, the operator of the loyalty program initiates a program in which the identified candidate merchants are contacted, and an agreement is reached to associate the identified candidate merchants with the loyalty program. Offers from the identified candidate merchants are entered into the offers database 55, so that, when method 100 is performed in the future, those details may be accessed in step 103.

Optionally, the redemption platform 54 may record which offers were selected by consumers in step 105 of method 100, and collate that information periodically to identify any of the presently associated merchants whose offers are not often accepted by consumers. The identified associated merchants may be disassociated from the loyalty program, and their offers are deleted from the offers database 55.

In this way, the loyalty program ensures that rewards options are available which reflect the consumers' preferences, and that the rewards catalogue changes in line with consumer preferences. This improves the experience for the consumers and “gamifies” the engagement process.

In step 111 (which may be performed with a timing independent from steps 109 and 110) the redemption platform uses the data in the choices database 57 to infer characteristics of the corresponding consumers, and store those details in a marketing database 58. For example, the consumer choices may be indicative of types of product which the corresponding consumers wish to obtain, so this information may be supplied to merchants who offer those products, to assist them to supply marketing information to those consumers (step 112).

In another possibility, the information obtained in step 111 may be used to allocate the consumers to corresponding consumer market segments (e.g. identifying consumers who are typically travelers or gamblers).

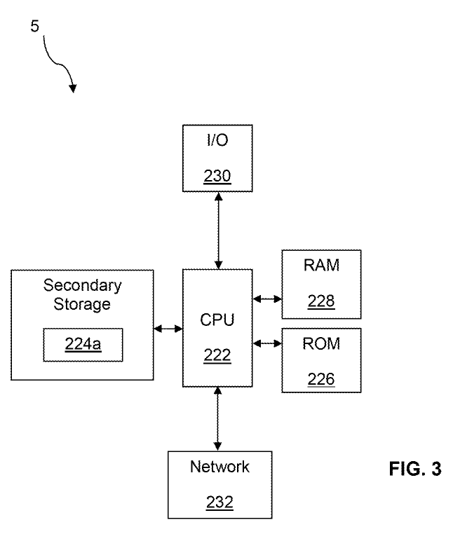

FIG. 3 is a block diagram showing a technical architecture of the loyalty program server 5. The payment network server 7 may also have this technical architecture, and/or as mentioned above the loyalty program server 5 and payment network server 7 may be implemented in a single server having the structure of FIG. 3.

The technical architecture includes a processor 222 (which may be referred to as a central processor unit or CPU) that is in communication with memory devices including secondary storage 224 (such as disk drives), read only memory (ROM) 226, random access memory (RAM) 228. The processor 222 may be implemented as one or more CPU chips. The technical architecture may further comprise input/output (I/O) devices 230, and network connectivity devices 232.

The secondary storage 224 is typically comprised of one or more disk drives or tape drives and is used for non-volatile storage of data and as an over-flow data storage device if RAM 228 is not large enough to hold all working data. Secondary storage 224 may be used to store programs which are loaded into RAM 228 when such programs are selected for execution.

In this embodiment, the secondary storage 224 has a processing component 224a comprising non-transitory instructions operative by the processor 222 to perform various operations of the method of the present disclosure. The ROM 226 is used to store instructions and perhaps data which are read during program execution. The secondary storage 224, the RAM 228, and/or the ROM 226 may be referred to in some contexts as computer readable storage media and/or non-transitory computer readable media.

I/O devices 230 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 232 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 232 may enable the processor 222 to communicate with the Internet or one or more intranets. With such a network connection, it is contemplated that the processor 222 might receive information from the network, or might output information to the network in the course of performing the above-described method operations. Such information, which is often represented as a sequence of instructions to be executed using processor 222, may be received from and outputted to the network, for example, in the form of a computer data signal embodied in a carrier wave.

The processor 222 executes instructions, codes, computer programs, scripts which it accesses from hard disk, floppy disk, optical disk (these various disk based systems may all be considered secondary storage 224), flash drive, ROM 226, RAM 228, or the network connectivity devices 232. While only one processor 222 is shown, multiple processors may be present. Thus, while instructions may be discussed as executed by a processor, the instructions may be executed simultaneously, serially, or otherwise executed by one or multiple processors.

Although the technical architecture is described with reference to a single server (computer), it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 220 to provide the functionality of a number of servers that is not directly bound to the number of computers in the technical architecture 220. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 222, the RAM 228, and the ROM 226 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

Whilst the foregoing description has described exemplary embodiments, it will be understood by those skilled in the art that many variations of the embodiment can be made within the scope and spirit of the present disclosure.

1. A computer implemented method of operating a loyalty program using a computer system, the method including:
transmitting to communication devices associated with a corresponding plurality of consumers, who are members of the loyalty program, information describing at least one merchant, wherein the at least one merchant is a merchant that does not currently offer products in return for loyalty points of the loyalty program;
receiving, from the communication devices, selection data characterizing selections from among the at least one merchant; and
collating the selection data to identify the at least one merchant, wherein the at least one merchant was selected by a number of the consumers that meets a criterion, the criterion indicating that the at least one merchant has been selected by a large number of the consumers.

2. A computer implemented method of claim 1 further including initiating a process of associating the identified at least one merchant with the program, whereby consumers who are members of the loyalty program can obtain products from the identified at least one merchant using loyalty points of the loyalty program.

3. A method according to claim 1, wherein the information describing the at least one merchant is transmitted to the communication devices with or following transmission of additional data describing offers made by merchants associated with the program to supply corresponding products in return for loyalty points of the loyalty program.

4. A method according to claim 1, wherein the information describing the at least one merchant is transmitted only to the communication devices of consumers, for which data has been received specifying that those consumers desire to use loyalty points of the loyalty program in one of a set of at least one predetermined way, wherein the at least one predetermined way does not include using the loyalty points to obtain products from merchants associated with the loyalty program.

5. A method according claim 1, further including analyzing the selection data to identify products desired by the consumers, and initiating a process of providing to the consumers marketing information relevant to the products.

6. A method according to claim 1, further including analyzing the selection data to allocate the consumers into corresponding ones of a plurality of market segments.

7. A method according to claim 1, further including transferring loyalty points of the loyalty program to a loyalty program of a merchant identified by the selection data.

8. A computer system for operating a loyalty program, the computer system comprising:
an accounts database for storing data describing loyalty accounts of a plurality of consumers who are members of the loyalty program;
an offers database for storing data describing products which can be obtained in exchange for loyalty points of the loyalty program from merchants associated with the loyalty program;
a candidate merchant database for storing candidate merchant data describing at least one candidate merchant, wherein the at least one candidate merchant is a merchant that does not currently offer products in return for loyalty points of the loyalty program;
a redemption platform configured to:
transmit, using a communication interface, the candidate merchant data to communication devices associated with the consumers;
receive, from the communication devices, selection data characterizing selections from among the at least one candidate merchant; and
collate the selection data to identify the at least one candidate merchant, wherein the at least one candidate merchant was selected by a number of the consumers that meets a criterion, the criterion indicating that the at least one candidate merchant has been selected by a large number of the consumers.

9. A computer system according to claim 8, wherein the redemption platform is further configured to instruct the communication devices to display additional data describing offers made by merchants associated with the program to supply corresponding products in return for loyalty points of the loyalty program, and to transmit the candidate merchant data to the communication devices for display either with or following the display of the additional data.

10. A computer system according to claim 8, wherein the redemption platform is further configured to receive, from the communication devices, data specifying that the corresponding consumers desire to use loyalty points of the loyalty program in one of a set of at least one predetermined way, and to transmit the candidate merchant data to the communication devices in response to that data.

11. A computer system according to claim 8, wherein the redemption platform is further configured to analyze the selection data to identify products desired by the consumers.

12. A computer system according to claim 8, wherein the redemption platform is further configured to analyze the selection data to allocate the consumers into corresponding ones of a plurality of market segments.

13. A computerized network comprising a server according to claim 8, and further comprising a plurality of communication devices configured to communicate with the server over a communication network.

14. A computer system according to claim 9, wherein the redemption platform is further configured to analyze the selection data to identify products desired by the consumers.

15. A computer system according to claim 10, wherein the redemption platform is further configured to analyze the selection data to identify products desired by the consumers.

16. A computer system according to claim 9, wherein the redemption platform is further configured to analyze the selection data to allocate the consumers into corresponding ones of a plurality of market segments.

17. A computer system according to claim 10, wherein the redemption platform is further configured to analyze the selection data to allocate the consumers into corresponding ones of a plurality of market segments.

18. A computerized network comprising a server according to claim 9, and further comprising a plurality of communication devices configured to communicate with the server over a communication network.

19. A computerized network comprising a server according to claim 10, and further comprising a plurality of communication devices configured to communicate with the server over a communication network.
